(19) United States
(12) Patent Application Publication
(10) Pub. No.: US 2026/0245036 A1
(43) Pub. Date: Aug. 20, 2026

(54) COMMODITY TRANSFER APPARATUS AND CONTROL METHOD FOR SAME

(71) Applicant: TELEXISTENCE INC., Tokyo (JP)

(72) Inventors: Pavel SAVKIN, Tokyo (JP); Joni VAEAETAEINEN, Tokyo (JP)

(73) Assignee: TELEXISTENCE INC., Tokyo (JP)

(21) Appl. No.: 18/992,755

(22) PCT Filed: Jul. 27, 2023
(86) PCT No.: PCT/JP2023/027500

§ 371 Date: Nov. 6, 2025

(30) Foreign Application Priority Data
Jul. 29, 2022 (JP) 2022-121930

(51) Int. Cl. G06Q 10/087; G06T 7/73

(52) U.S. Cl. CPC G06Q 10/08724; G06T 7/74; G06T 2207/20081

(57) ABSTRACT

According to one embodiment of the present disclosure, a product transfer apparatus 1 is provided. The product transfer apparatus 1 includes an arm unit 20 having a holder unit 10 for holding a product, an image capture unit 60 for obtaining image data including at least a portion of the product held by the holder unit 10, and a control unit 150. The control unit 150 is configured to perform allowing the image capture unit 60 to obtain image data including at least a portion of the product held by the holder unit 10 for placing the product on the shelf plate of the product display shelf and placed at a position above the shelf plate by the arm unit 20, and determining whether or not the product has a posture in which the product can be placed on the shelf plate, based on the image data.

### TECHNICAL FIELD

The present disclosure relates to a product transfer apparatus and a method of controlling the product transfer apparatus.

### BACKGROUND

JP2018-110755 discloses a product replenishment system which performs unmanned replenishment of products to reduce work labor. This product replenishment system includes an image capture device for capturing an image of a product as a target of replenishment, and a multi-joint robot apparatus for moving the product. The multi-joint robot apparatus picks up a product as the target of replenishment from a predetermined position where the product is placed beforehand, and moves the product to a product display shelf.

### SUMMARY

In the system described in JP2018-110755, in general, the position of the product display shelf or the product recognized by the system through an image recognition technique, etc. may be different from the actual position of the product display shelf or the product. As an example of such a difference, in the presence of a difference where the height of the product held by a holder unit of an actual multi-joint robot apparatus is lower than a predetermined height relative the product display shelf, if operation of moving the product by the holder unit in this state to place the product at a movement destination position on the product display shelf is performed, the bottom of the product held by the holder unit contacts the edge of the product display shelf, and the product may be tilted obliquely relative to the holder unit. If the product is transported to a position above the product display shelf while the product is held by the holder unit in such an obliquely tilted state, and then the holder unit releases the holding of the product for placement of the product on the product display shelf, the product will fall over on the product display shelf.

If a product falls over on the product display shelf, it becomes necessary to remotely operate the multi-joint robot apparatus to hold the product by the holder unit again, and correct the posture of the product. However, in the case where the product display shelf has a slope to move the product toward the front side, the product may slide down along the slope to the front side of the product display shelf and the holder unit may not be able to reach the product. Further, since the distance between the upper and lower shelf plates of the product display shelves is not very wide, it is difficult for the holder unit to access the products to pick up the fallen over products, or even if it is possible for the holder unit to access the product, advanced technology for remotely controlling the multi-joint robot apparatus and the holder unit is required. For this reason, once a product has fallen over on the product display shelf, it is virtually impossible to correct the posture of the product by remote control of the multi-joint robot apparatus and the holder unit, and the posture of the fallen product may have to be corrected manually by store staff again. Therefore, in the case where the posture of the product is changed while the holder unit holds, and moves the product, in this state, it is desirable to release the holding to prevent the product from falling over.

An object of the present disclosure is to provide a product transfer apparatus, etc., which makes it possible to prevent operation of placing a product on a shelf plate from being performed while the product held by the holding unit is still in a posture in which the product may fall over on the shelf plate.

According to an aspect of the present disclosure, a product transfer apparatus configured to move a product placed on a stock shelf to a product display shelf which is different from the stock shelf is provided. The product transfer apparatus includes an arm unit having a holder unit configured to hold the product, an image capture unit configured to obtain image data including the holder unit and at least a portion of the product held by the holder unit, and a control unit configured to control operation of the holder unit, the arm unit, and the image capture unit. The control unit is configured to perform allowing the image capture unit to obtain image data including at least a portion of the product held by the holder unit for placing the product on the shelf plate of the product display shelf and placed at a position above the shelf plate by the arm unit, and determining whether or not the product has a posture in which the product can be placed on the shelf plate, based on the image data.

Other features and advantages of the present disclosure can be understood from the following description and the accompanying drawings which are given in an illustrative and non-comprehensive manner.

The present disclosure provides a product transfer apparatus, etc. which makes it possible to prevent operation of placing a product on a shelf plate from being performed while the product held by the holding unit is still in a posture in which the product may fall over on the shelf plate.

### BRIEF DESCRIPTION OF THE DRAWINGS

FIG. 1 is a plan view schematically showing the layout of shelves in a store and a product transfer apparatus provided in the store;

FIG. 2(a) is a view showing a product display shelf viewed from the front side, and FIG. 2(b) is a view showing the product display shelf viewed from the back side;

FIG. 3 is a side view schematically showing structure of the product transfer apparatus;

FIG. 4 is a perspective view showing structure around a front end of an arm unit of the product transfer apparatus;

FIG. 5 is a block diagram showing structure of the product transfer apparatus;

FIG. 6 is an image of a product display shelf captured by a first camera (left side) of the product transfer apparatus;

FIG. 7 is a view showing a state where various products held by the holder unit is moved to a position above a product placement position of a shelf plate of the product display shelf where FIG. 7(a) shows an example of moving a product of a canned beverage, FIG. 7(b) shows an example of a posture in which the product of the canned beverage contacted a guard portion of the shelf plate at the time of moving the product, and the product is tilted, FIG. 7(c) shows an example of a posture in which the product of the canned beverage contacted an upper shelf plate at the time of moving the product, and the product is tilted, and FIG. 7(d) shows an example of a posture in which a product of a PET bottle beverage contacted to a guard portion of the shelf plate at the time of moving the product, and the product is tilted, and then, the product is returned to the original posture by its own weight;

FIG. 8 is a view showing an example of a capture image captured when the product held by the holder unit is moved to a position above the product placement position of the shelf plate of the product display shelf;

FIG. 9 is a flow chart showing replenishment operation of the product by the product transfer apparatus;

FIG. 10 is a flow chart showing a first operation example of the product transfer apparatus;

FIG. 11 is a comparative conceptual view showing a posture of a product held by a holder unit, captured by a second camera of the product transfer apparatus, where a solid line shows a product having a posture without inclination relative to the holder unit, a broken line shows a product having a posture with inclination in a direction toward the holder unit, and one dotted line shows a product having a posture with inclination in a direction away from the holder unit; and

FIG. 12 is a schematic view illustrating a fourth operation example of the product transfer apparatus.

### DETAILED DESCRIPTION

Hereinafter, an embodiment of the present disclosure will be described with reference to the drawings.

### Layout Structure of Store

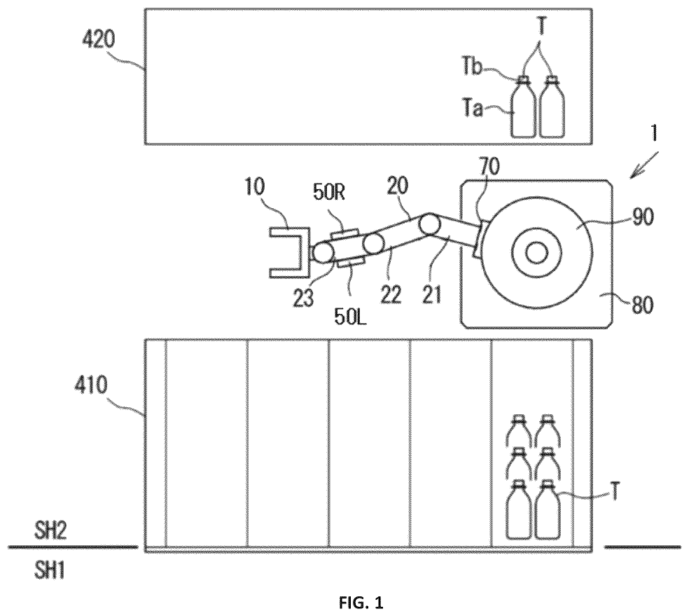

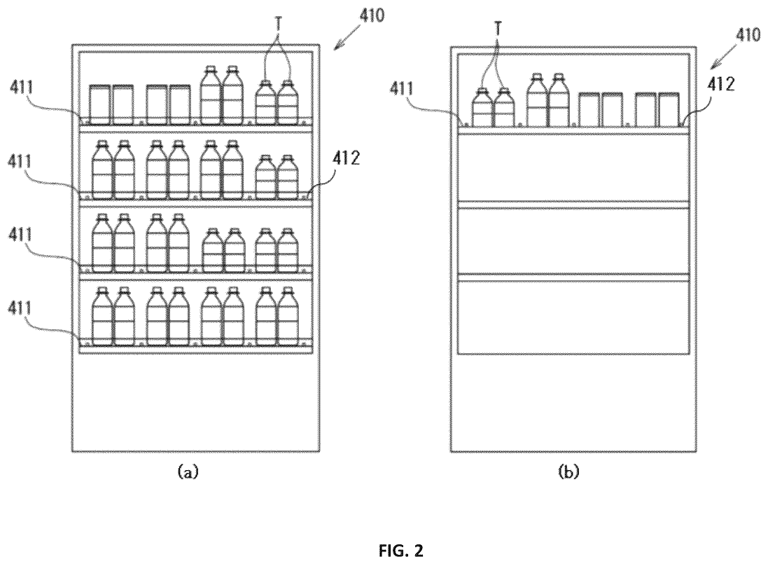

Firstly, layout structure of a store will be described. FIG. 1 is a plan view schematically showing the layout of shelves in a store and a product transfer apparatus provided in the store. FIG. 2(a) is a view showing a product display shelf viewed from the front side, and FIG. 2(b) is a view showing the product display shelf viewed from the back side.

As shown in FIG. 1, the inside of the store is divided into an in-store space SH1 and a backyard space SH2. The in-store space SH1 is a space where customers select and purchase products T. The backyard space SH2 is a space where the stock of the products T is stored. A product display shelf 410, a stock shelf 420, and a product transfer apparatus 1 are provided in the store.

As shown in FIG. 2(a) and 2(b), the product display shelf 410 has a plurality of shelf plates 411 (also referred to as the levels of the product display shelves). A plurality of types of products T are placed on the shelf plate 411. For example, the products T of the same type are arranged in two rows or three rows. The products T may be arranged in only one row. A plurality of partition plates 412 dividing the products T arranged in each row are provided on the upper surface of each of the shelf plates. In FIG. 2, an example of products T of the same type arranged in two rows is illustrated, and in this example, a partition plate 412 is provided for every two rows of products T. The layout of the partition plate 412 is not limited to the above example, and the partition plate 412 can be arranged at intervals of one row or two or more rows.

The front side of the product display shelf 410 faces the in-store space SH1. So, customers can take products T from the front side of the product display shelf 410. The shelf plate 411 is inclined such that the front side gets lower relative to the back side. In the structure, when a customer takes a product T, other products T arranged behind the product T slide on the shelf plate 411, and move toward the front side.

The back side of the product display shelf 410 faces the backyard space SH2. So, a store employee or the product transfer apparatus 1 can replenish the product display shelf 410 with the products T from the back side of the product display shelf 410. Although not shown in the drawings, doors may be provided on the front and back sides of the product display shelf 410. In FIG. 1, though only one product display shelf 410 is drawn for simplicity of illustration, a plurality of product display shelves 410 may be provided in the store.

In the backyard space SH2, the stock shelf 420 is provided to face the product display shelf 410, and the front surface of the stock shelf 420 and the back surface of the product display shelf 410 face each other. As in the case of the product display shelf 410, the stock shelf 420 includes a plurality of shelf plates (levels) disposed in the height direction. Replenish target products as target products of replenishment for the product display shelf 410 are arranged on the shelf plate of the stock shelf 420. The replenishment target products may be arranged by a store employee, or the product transfer apparatus 1.

### Structure of the Product Transfer Apparatus 1

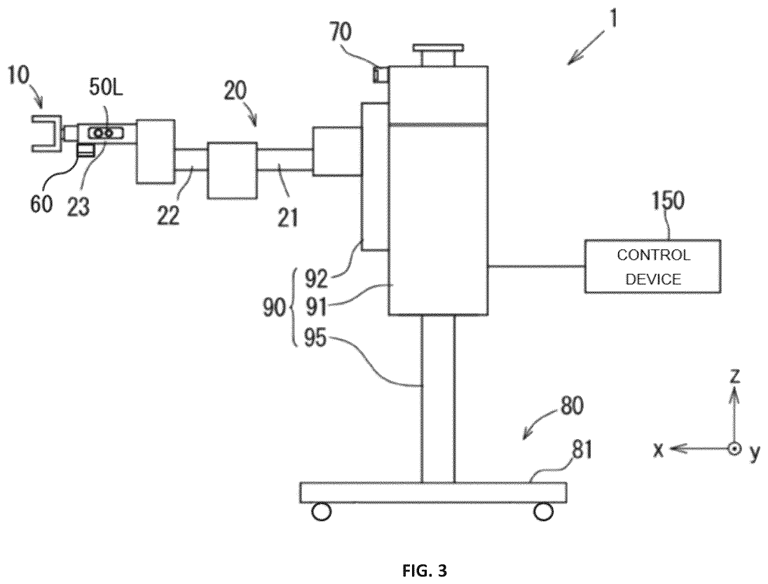

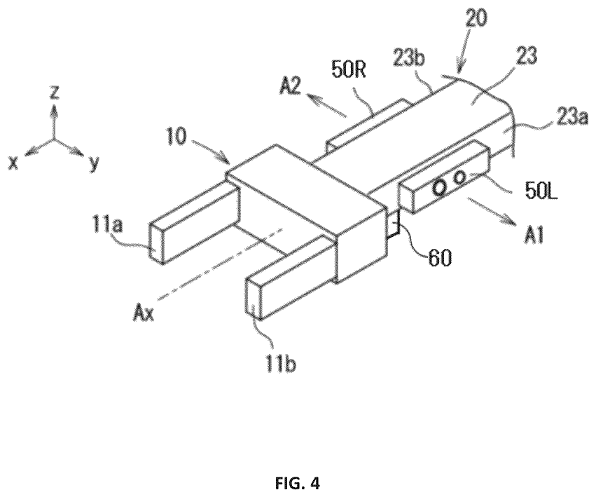

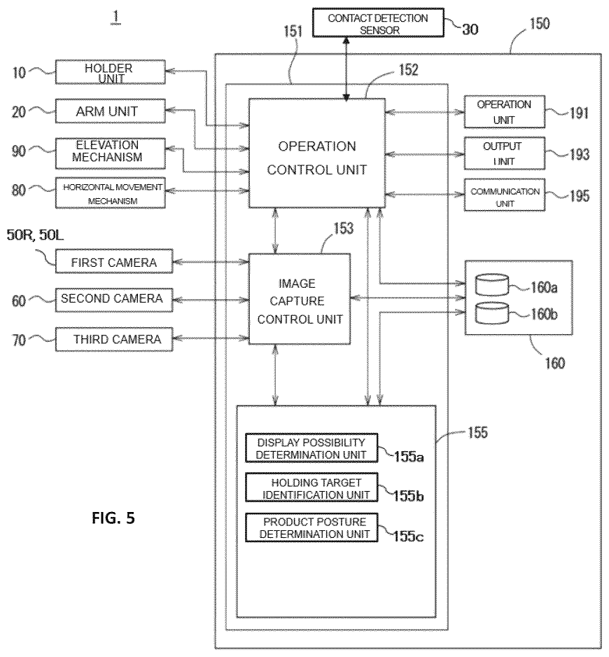

The product transfer apparatus 1 will be described with reference to FIG. 1, and 3 to 5. FIG. 3 is a side view schematically showing structure of the product transfer apparatus 1. FIG. 4 is a perspective view showing structure around a front end of an arm unit of the product transfer apparatus 1. FIG. 5 is a block diagram showing structure of the product transfer apparatus 1.

The product transfer apparatus 1 includes a holder unit 10, an arm unit 20, a contact detection sensor 30, first cameras 50R, 50L, a second camera 60, a third camera 70, a horizontal movement mechanism 80, an elevation mechanism 90, and a control device 150. The product transfer apparatus 1 is a robot which moves in a space between the product display shelf 410 and the stock shelf 420. The product transfer apparatus 1 holds a product T in the stock shelf 420 by the holder unit 10, and thereafter, moves the product T held by the holder unit 10 to a display position of the product T, of the product display shelf 410 (lane which displays the product T).

As shown in FIG. 4, the holder unit 10 includes a pair of holder members 11a, 11b for holding a target object. The pair of holder members 11a, 11b have a shape configured to hold the product T which is a PET bottle beverage at a position near the cap member Tb. Further, the pair of holder members 11a, 11b have a shape configured to hold an outer peripheral portion of the product T which is a canned beverage. The holder unit 10 may not be formed by the pair of holder members 11a, 11b. Alternatively, the holder unit 10 may be configured to hold a target object by adsorption or may be configured to hold a target object by using an adhesive force, a magnetic force, etc.

The arm unit 20 includes a plurality of link members 21, 22, 23. The plurality of link members 21, 22, 23 form a multi-joint robot arm. For example, the multi-joint robot arm may be a 6-axis arm with degrees of freedom in a straight direction along each of the X, Y, and Z axis directions, and with degrees of freedom in each of the directions about the X, Y, and Z axes. The multi-joint robot arm may have any other mechanism, such as an orthogonal coordinate system robot arm, a polar coordinate system robot arm, a cylindrical coordinate system robot arm, or a SCARA robot arm. One end of the arm unit 20 is fixed to the elevation mechanism 90. The holder unit 10 is provided at a front end of the arm unit 20. Operation of the arm unit 20 is controlled by the control device 150.

The arm unit 20 can move the holder unit 10 toward the stock shelf 420 or toward the product display shelf 410 by moving respective link members 21, 22, 23. The orientation of the arm unit 20 is not fixed to a certain direction. However, for the sake of explanation, the direction in which the respective link members 21, 22, 23 are extended will be referred to as the extension direction Ax of the arm unit 20 (see FIG. 4). The arm unit 20 moves the holder unit 10 forward toward the product T to hold the product T. The extension direction Ax of the arm unit 20 corresponds to the forward direction of the holder unit 10 in the holding operation.

The contact detection sensor 30 is a sensor which detects that the product T held by the holder unit 10, the holder unit 10 or the arm unit 20 contacts an obstacle such as a wall or a pillar of the product display shelf 410 at the time of placing the product T held by the holder unit 10 on the shelf plate 411 of the product display shelf 410. For example, a torque sensor, an acceleration sensor, an inertial measurement unit (IMU), a motor input current sensor, etc. can be used as the contact detection sensor 30.

For example, a strain gauge can be used as a torque sensor to detect the torque generated in the shaft of each joint of the arm unit 20. Various types of acceleration sensors, such as capacitance type or piezoresistive type, mounted on the holder unit 10 or the arm unit 20 can be used as the acceleration sensors.

The inertial measurement unit (IMU) is a device which detects three-dimensional inertial motion (translational and rotational motion in three orthogonal axes), and the inertial measurement unit (IMU) is equipped with an acceleration sensor to detect translational motion and an angular velocity (gyro) sensor to detect rotational motion. Among these sensors, the gyro sensor can be used to detect angular velocity to obtain the angle or angular change of the target object. For example, in the case where gears or gears and toothed belts are used as drive transmission means for the wrist portion of the holder unit 10, the motion of the wrist portion of the holder unit 10 can have redundancy due to play between gears or stretching of the toothed belt. So, for example, during the operation of placing the product T held by the holder unit 10 on the shelf plate 411 of the product display shelf 410, in the state where the product T is in contact with the upper surface of the shelf plate 411, if an additional force is applied to the holder unit 10 by moving the arm unit 20 further, as a result, some displacement will be caused in the wrist portion of the holder unit 10, and the posture (i.e., angle) of the holder unit 10 changes. Therefore, such angular changes which may occur in the holder unit 10 during the operation of placing the product T on the shelf plate 411 can be detected by the IMU mounted on the holder unit 10 to detect that the product T has come into contact with the shelf plate 411.

In the case where a servomotor etc. is used to drive each joint of the arm unit 20, when an external force which causes an angle deviation from the angle at which the holding posture is maintained occurs, the servomotor operates to keep the angle deviation at zero in order to maintain the original angle. In the state where the product T held by the holder unit 10, the holder unit 10 or the arm unit 20 is in contact with an obstacle, such as a wall or a pillar of the product display shelf 410, at the time of moving the arm unit 20 further, current is input to the servomotor to drive the servomotor in opposition to the load. Therefore, by detecting the current inputted to the servomotor for such operation using the motor input current sensor, it is possible to detect that the product T held by the holder unit 10, the holder unit 10 or the arm unit 20 is in contact with an obstacle such as the wall or the pillar of the product display shelf 410. For example, the motor input current sensor may be in the form of a control unit 151 (see FIG. 5) described later.

Two first cameras 50R, 50L are provided on both of the left and right sides of the arm unit 20, respectively. The first cameral 50L mounted on the first side surface 23a which is the left side of the arm unit 20 is oriented in a first orientation A1 along a direction perpendicular to the extension direction of the arm unit 20 (see FIG. 4). The first camera 50L is used for mainly capturing an image of the product display shelf 410. The first camera 50R mounted on a second side surface 23b which is the right side of the arm unit 20 in parallel to the first side surface 23a and opposite to the first side surface 23a is oriented in a second orientation A2 which is opposite to the first orientation A1. The first camera 50R is used for mainly capturing an image of the stock shelf 420. As described above, the first cameras 50R, 50L are disposed in opposite directions to each other. Therefore, while keeping the arm unit 20 in the same posture, it is possible to capture images of the product display shelf 410 and the stock shelf 420 by the first cameras 50R, 50L, respectively, at the same time.

The performance of the first camera 50R and the performance of the first camera 50L may be the same, or may be different. Hereinafter, for the purpose of brevity of description, an example where both of the cameras have the same performance will be described. It should be noted that the purpose and/or the condition of capturing the image of the product display shelf 410 and the purpose and/or the condition of capturing the image of the stock shelf 420 are different. Therefore, it is a matter of course that cameras having different performances may be used depending on the respective purposes and conditions.

For example, the first cameras 50R, 50L may have an image capture element and a depth sensor. The image capture element generates a capture image (RGB image in one example) in which pixels are arranged in two dimensions. The depth sensor is a distance detection device for generating distance data. The depth sensor is not limited to a certain type as long as the depth sensor is capable of obtaining data of the distance to the target object. For example, the depth sensor may use a stereo lens system or a LiDAR (Light Detection and Ranging) system. For example, the depth sensor may generate Depth images. In other embodiments of the present invention, either or both of the first cameras 50R, 50L may, for example, utilize an ultrasonic element to obtain the distance data.

It should be noted that the first camera 50L is oriented in the first orientation A1. This means that the image capture direction of the image capture element and the depth sensor of the first camera 50L is the orientation A1. Likewise, the second camera 60 is oriented in the second orientation A2. This means that the image capture direction of the image capture element and the depth sensor of the first camera 50R is in the orientation A2. The orientations A1 and A2 do not necessarily have to be 180° opposites to each other, as long as the orientations A1 and A2 allow image capturing of the product display shelf 410 and the stock shelf 420.

One or both of the first cameras 50L, 50R may be provided on the holder unit 10. The first cameras 50L, 50R may not necessarily be provided on the same member. For example, the first camera 50R may be mounted on one of the link members 21 to 23, and the first camera 50L may be mounted on another one of the link members 21 to 23. However, in the case where the first cameras 50L, 50R are provided on the same member, in comparison with the case where the cameras 50L, 50R are provided on separate link members, respectively, there is an advantage that image processing computation is simplified because a common coordinate system is used.

The second camera 60 is used to capture an image showing the state where the holder unit 10 holds the product T, and the positional relationship between the product T held by the holder unit 10 and the shelf plate 411 of the product display shelf 410. As in the case of the first cameras 50R, 50L, the second camera 60 may have an image capture element and a depth sensor. The image capture element generates a capture image (RGB image in one example) in which pixels are arranged in two dimensions. The depth sensor generates distance data.

For example, the second camera 60 may be provided below the link member 23 closest to the holder unit 10, among the link members 21 to 23 of the arm unit 20, at a position close to the holder unit 10. The image capturing direction of the imaging element and the depth sensor of the second camera 60 are oriented directly downward (in the −z direction in FIGS. 3 and 4) or downward forward (somewhat more +x direction than in the −z direction in FIGS. 3 and 4) of the link member 23 and the holder unit 10. In the structure, the second camera 60 can capture the holder unit 10 and at least a portion of the product T held by the holder unit 10.

The third camera 70 is a camera for capturing an image of a predetermined target object by changing the orientation, e.g., in accordance with operation of an operator at a remote location. For example, the third camera 70 is mounted on part of the elevation mechanism 90. The third camera 70 is capable of moving horizontally and vertically in a space between the product display shelf 410 and the stock shelf 420, in accordance with operation of the horizontal movement mechanism 80 and the elevation mechanism 90. Further, the portion of the elevation mechanism 90 on which the third camera 70 is mounted is rotatable about a pillar 95, and the third camera 70 is configured to rotate and move left and right about the pillar 95 as the portion rotates, and capture the image of the product display shelf 410 and capture the image of the stock shelf 420 as necessary.

For example, the third camera 70 may adopt a stereo lens system. Although not limited, the third camera 70 may have a wide angle of view in comparison with the first cameras 50L, 50R and the second camera 60.

The horizontal movement mechanism 80 has a base plate 81 and a drive mechanism (not shown). The base plate 81 supports the elevation mechanism 90, and slides along a rail (not shown) provided between the product display shelf 410 and the stock shelf 420 in the store. The drive mechanism (not shown) includes a motor, a roller, etc., and operates based on a control signal from the control device 150 (see FIG. 5) to move the elevation mechanism 90 to a predetermined position along the rail.

The elevation mechanism 90 has the pillar 95, a first elevation mechanism 91, and a second elevation mechanism 92. The pillar 95 is fixed on the base plate 81 and extends in the vertical direction.

The first elevation mechanism 91 has a drive mechanism (not shown). The drive mechanism (not shown) includes components such as a motor and a linear guide, and operates based on a control signal from the control device 150 (see FIG. 5). By operating the drive mechanism (not shown), the first elevation mechanism 91 moves vertically up and down along the pillar 95. The upper portion of the first elevation mechanism 91, to which the third camera 70 is attached, is configured to be driven to rotate in the left-right direction about the pillar 95.

The second elevation mechanism 92 is held by the first elevation mechanism 91. One end of the arm unit 20 is attached to the second elevation mechanism 92. The second elevation mechanism 92 has a drive mechanism (not shown). The drive mechanism (not shown) includes a motor, a linear guide, etc., and operates based on a control signal from the control device 150 (see FIG. 5). By operating the drive mechanism (not shown), the second elevation mechanism 92 also moves vertically up and down.

In the case of holding a product T which is present at a predetermined height, the elevation mechanism 90 moves the arm unit 20 and the holder unit 10 by the first elevation mechanism 91 to a height around which the product T can be held, and finely adjusts the height of the arm unit 20 and the holder unit 10 by the second elevation mechanism 92.

In the present embodiment, the first elevation mechanism 91 and the second elevation mechanism 92 are provided as elevation mechanisms. However, in other embodiments of the present invention, only one elevation mechanism may be provided.

### Structure of the Control Device 150

As shown in FIG. 5, the control device 150 has the control unit 151, a memory unit 160, an input unit 191, an output unit 193, and a communication unit 195. In FIG. 5, though the control device 150 is drawn as a single element, the control device 150 does not necessarily have to be a physically single element, but may be composed of a plurality of elements that are physically separated from each other.

The input unit 191 is a device for receiving input from the operator. The input unit 191 may be made up of devices such as a keyboard, a mouse, a touch panel, etc. for providing input to a computer. The input unit 191 may have an audio input device such as a microphone. The input unit 191 may have a gesture input device which recognizes and identifies operator's movements through image recognition.

The output unit 193 is used for allowing the product transfer apparatus 1 to output an alert to a store employee, etc. For example, the output unit 193 is made up of one of, or a combination of devices such as a speaker, a display, a light-emitting deice, and a vibration device. The communication unit 195 has a function of receiving data from the outside and transmitting data to the outside. In the case where the product transfer apparatus 1 is configured to be operated remotely, an input from the operator through an operation unit of an external device (not shown) is received by the communication unit 195, and the control device 150 allows the product transfer apparatus 1 to perform a predetermined operation based on the input. Preferably, the product transfer apparatus 1 is able to switch between an autonomous operation mode and a remote operation mode, and this switching can be done by input from the operator via the operation unit of an external device (not shown). Communication between the operation unit of the external device and the communication unit 195 may be either wired communication or wireless communication.

In the case where the product transfer apparatus 1 is configured to be operated remotely, the operation unit 191 may be a device worn by the operator. The device includes a display device (not shown) and an operation device (not shown). The display device has a display which is visible to the operator. For example, the display device may be a head mount display (HMD). For example, the operation device may include one or more input sensors which can detect movement of the operator's body parts (e.g., hands and arms).

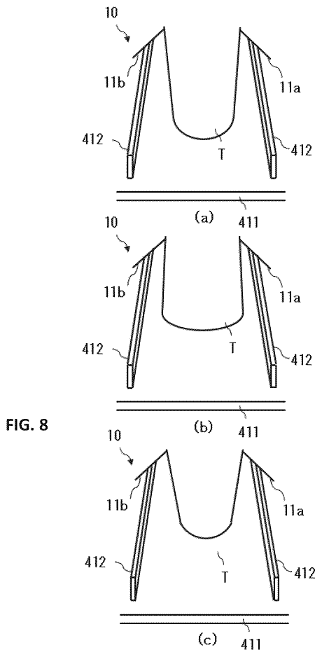

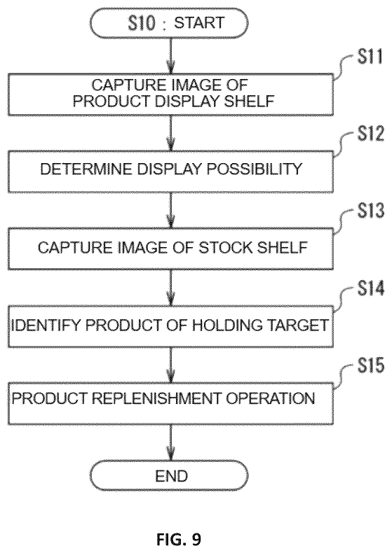

The memory unit 160 includes a transitory or non-transitory storage medium such as a ROM (Read Only Memory), a RAM (Random Access Memory) and a HDD (Hard Disk Drive). The memory unit 160 stores computer programs executed by the control unit 151, and/or learned models, etc., which will be described later. The computer programs stored in the memory unit 160 includes an instruction for performing a method of controlling the product transfer apparatus 1 by the control unit 151, which will be described later with reference to FIGS. 8 and 9, etc.

The memory unit 160 includes an acquisition data memory unit 160a and a reference data memory unit 160b. The acquisition data memory unit 160a stores capture image data, etc. captured by each of the cameras 50R, 50L, 60, 70. The reference data memory unit 160b stores various items of data necessary for operation of the product transfer apparatus 1. The various items of data include data regarding the product display shelf 410 and the stock shelf 420 (various items of shape data, position data, or lane coordinate data, etc.), and data regarding the product T (shape data, position data, etc.).

The control unit 151 is made up of one, or two or more CPUs (Central Processing Unit). The control unit 151 functions as an operation control unit 152, an image capture control unit 153, and an image data processing unit 154 by executing a computer program stored in the memory unit 160.

The operation control unit 152 generates control signals for operating each of the holder unit 10, the arm unit 20, the horizontal movement mechanism 80, the elevation mechanism 90, and the control device 150. The operation control unit 152 generates the control signals with reference to input signals from the operation unit 191 and/or various items of data stored in the memory unit 160. Generation of the control signal may be performed by using the processing results of an image data processing unit 155. The operation control unit 152 transmits/receives data via the communication unit 195, and generates a predetermined output via the output unit 193.

The image capture control unit 153 controls operation of each of the cameras 50R, 50L, 60, 70. The image capture timing, etc. of each of the cameras 50R, 50L, 60, 70 may be determined using data stored in the reference data memory unit 160b in advance.

The image data processing unit 155 performs various items of information processing using capture image data and the distance data (depth data) captured by image capturing by each of the cameras 50R, 50L, 60, 70. For example, the image data processing unit 155 analyzes an image of image data captured by the first camera 50R, and identifies the products arranged on the stock shelf 420. The image data processing unit 155 has a display possibility determination unit 155a, a holding target identification unit 155b, and a product posture determination unit 155c.

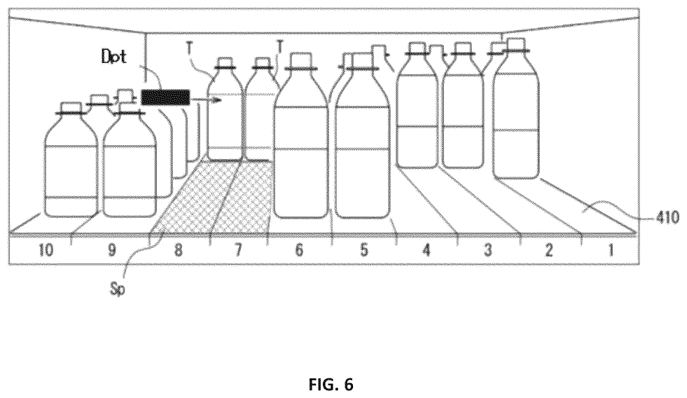

Based on at least one of the capture image data generated by image capturing of the first camera 50L and the distance data, the display possibility determination unit 155a determines, for example, whether or not a space Sp (see FIG. 6) is present to place more products behind the rearmost product T arranged on the product display shelf 410. FIG. 6 shows an image of the product display shelf 410 captured by the first camera 50L of the product transfer apparatus 1. If a space Sp is present, it means that the product T needs to be replenished. Therefore, if the space Sp is present, the display possibility determination unit 155a transmits a notification indicating that the product T should be replenished on the shelf plate 411 below the space Sp, to the operation control unit 151. In the case where the operation control unit 151 receives this notification, the operation control unit 151 performs replenishment operation for the product T.

Based on at least one of the capture image data captured by the first camera 50R and the distance data, the holding target identification unit 155b performs at least one of determination of whether or not the replenishment target product as a holding target is present in the stock shelf 420, identification of the size or shape of the replenishment target product, and determination of a holding position of the replenishment target product. In the case where the product T has the cap member Tb as shown in FIG. 1, for example, the holding target identification unit 155b sets a position near the cap member Tb as the holding position. In the case where the product T does not have the cap member Tb, the holding target identification unit 155b may set a side portion of the container as the holding position.

The product posture determination unit 155c analyzes image data of a capture image captured by the second camera 60 when the product T held by the holder unit 10 moves to a position above the product placement position (lane of the placement target) of the shelf plate 411 of the product display shelf 410, and identifies whether or not the posture of the product T relative to the holder unit 10 (in particular, the holder members 11a, 11b) is a posture in which the product T can be placed on the shelf plate 411.

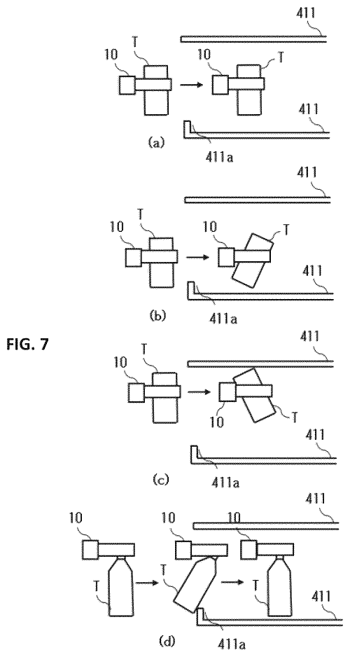

FIG. 7 is a view showing a state where the product T held by the holder unit 10 is moved from the back side of the product display shelf 410 to the shelf plate 411. FIG. 7(a) to FIG. 7(c) show an example where an outer peripheral portion of a product T of a canned beverage is held, and FIG. 7(d) shows an example, where an outer peripheral portion of a cap member of the product T of a PET bottled beverage is held.

As shown in FIG. 7(a), in the state where the bottom of the product T is located in the predetermined height range higher than the height of a guard portion 411a provided on the back side of the lower shelf plate 411, if the holder unit 10 is moved in the direction of an arrow in the figure while maintaining the height, the bottom of the product T does not contact the guard portion 411a, and the product T is transported to a position above the product placement position on the lower shelf plate 411 while maintaining the posture when the product T was initially held by the holder unit 10. In contrast, as shown in FIG. 7(b), in the state where there is an error in the height position of the product T and the bottom of the product T is lower than the height of the guard portion 411a on the back side of the lower shelf plate 411, if the holder unit 10 is moved in the direction of an arrow in the figure while maintaining the state, the bottom of the product T contacts the guard portion 411a, and the product T is rotated about the contact portion with the holder members 11a, 11b as a fulcrum to take a posture tilted obliquely relative to the holder unit 10, and the product T is transported to a position above the product placement position of the lower shelf plate 411. Further, as shown in FIG. 7(c), in the state where there is an error in the height position of the product T and the top of the product T is higher than the height of the upper shelf plate 411, if the holder unit 10 is moved in the direction of an arrow shown in the figure while maintaining the state, the top of the product T contacts the edge of the upper shelf plate 411, and the product T is rotated about the contact portion with the holder members 11a, 11b as a fulcrum and the product T is tilted obliquely relative to the holder unit 10 in the opposite direction to the case of FIG. 7(b). Then, the product T is transported to a position above the product placement position on the lower shelf plate 411. In the case where the holder unit 10 holds the outer peripheral portion of the product T of the canned beverage, the holding position becomes relatively close to the center of gravity of the product T, and in the case of the canned beverage, the contact area between the outer peripheral portion and the holder members 11a, 11b is relatively large, and thus, a relatively large frictional force is generated. So, once the product T is tilted obliquely relative to the holder unit 10, it is difficult for the product T to return to the original posture by its own weight.

In contrast, in the case where the holder unit 10 holds the outer peripheral portion of the cap member of the product T of the PET bottle beverage, the holding position is relatively remote from the center of gravity of the product T, and in the case of PET bottle beverage, the contact area between the outer peripheral portion of the cap member and the holder members 11a, 11b is relatively small, and thus, the generated frictional force is relatively small. So, even if the product T contacts the guard portion 411a and becomes tilted obliquely relative to the holder unit 10, the product T may rotate around the contact portion with the holder members 11a and 11b by its own weight of the product T after the product T exceeds the guard portion 411a and return to its original posture (see FIG. 7(d)).

FIG. 8 is a view showing an example of a capture image captured when the product T held by the holder unit 10 is transported to a position above the product placement position of the shelf plate 411 of the product display shelf 410. FIG. 8(a) shows a state where the product T held by the holder unit 10 as shown in FIG. 7(a) is moved to a position above the product placement position of the shelf plate 411 in the state where the product T does not contact the shelf plate, or returns to the original position by its own weight as shown in FIG. 7(d). In this case, the bottom of the product T defined by the contour having the curve on the lower side of the product T shown in the capture image is positioned relatively distant from the holder members 11a, 11b toward the lower side of the holder members 11a, 11b.

In contrast, FIG. 8(b) shows a state in which the product T held by the holder unit 10 as shown in FIG. 7(b) contacts the lower shelf plate 411, and tilted obliquely relative to the holder members 11a, 11b, and in this state, the product T is moved to a position above the product placement position on the shelf plate 411. In this case, the bottom of the product T shown in the capture image is positioned relatively close to the holder members 11a, 11b below the holder members 11 a, 11 b. Further, FIG. 8(c) shows a state where the product T held by the holder unit 10 contacted the upper shelf plate 411, and tilted obliquely relative to the holder members 11a, 11b in a direction opposite to the case of FIG. 7(b), and in this state, the product T is moved to a position above the product placement position of the shelf plate 411. In this case, the bottom of the product T shown in the capture image is at a position more remote from the holder members 11a, 11b toward the lower side of the holder members 11a, 11b.

The product posture determination unit 155c obtains, for example, the shape and size of the curved contour of the lower side of the product T and the length, the distance between each other, and the direction of inclination of the two straight contours on the left and right sides of the product T as characteristic information by using an arbitrary image recognition technique. Based on the obtained characteristic information, the product posture determination unit 155c identifies whether or not the product T held by the holder unit 10 is tilted relative to the holder unit 10, and moreover, at what angle the product T is tilted. Based on such identification results, the product posture determination unit 155c determines that, in the case where the product T held by the holder unit 10 is not tilted relative to the holder unit 10, or in the case where the product T is tilted but the tilt angle is smaller than a predetermined angle, the posture of the product T relative to the holder unit 10 is a posture in which the product T can be placed on the shelf plate 411. On the other hand, if the product T is tilted relative to the holder unit 10, it is determined that the posture of the product T relative to the holder unit 10 is not a posture in which the product T can be placed on the shelf plate 411.

The product posture determination unit 155c determines the posture of the product T with reference to at least one of the shape and size of the curved contour of the lower side the product T and the length, the distance between each other, and the inclination of the two straight contours on the left and right sides of the product T. Further, in the case where the distance (depth) data has been obtained by the second camera 60 as well, the product posture determination unit 155c may use the depth data in determining the posture of the product T relative to the holder unit 10.

When the product posture determination unit 155c determines that the posture of the product T relative to the holder unit 10 is not a posture in which the product T can be placed on the shelf plate 411, the operation control unit 152 transmits information notifying abnormality of the posture of the product T to an external device (not shown) through the communication unit 195. Such information can be in the from of a text message, a warning, an alarm, etc. When the external device (not shown) receives such information, the operator operates the external device to switch the product transfer apparatus 1 to a remote control mode. An input from the operator via the operation unit of the external device (not shown) is received by the communication unit 195, and the control unit 150 operates the product transfer apparatus 1 based on the input. The operator of the external device remotely operates the product transfer apparatus 1 so that the posture of the product T held by the holder unit 10 is corrected to a posture in which the product T can be placed on the shelf plate 411. After the posture correction of the product T is completed, the operator operates the external device to switch the product transfer apparatus 1 back to the original autonomous operation mode, and the product transfer apparatus 1 resumes operation of placing the product T on the shelf plate 411.

### Product Replenishment Operation by the Product Transfer Apparatus 1

FIG. 9 is a flow chart showing operation of replenishing the product T by the product transfer apparatus 1.

Firstly, in step S11, the first camera 50L mounted on the arm unit 20 of the product transfer apparatus 1 captures an image of the back side of the product display shelf 410. The product transfer apparatus 1 moves the arm unit 20, the horizontal movement mechanism 80, and the elevation mechanism 90 in a manner that an image of each level of the product display shelf 410 can be captured by the first camera 50L. Next, the product transfer apparatus 1 operates the first camera 50L to obtain an image of the back side of the product display shelf 410, and obtain the data of distance (distance data) to the product T arranged on the product display shelf 410.

Next, in step S12, display possibility determination is made. The “display possibility determination” is a step performed by the display possibility determination unit 155a in the image data processing unit 155 of the product transfer apparatus 1 to determine which products T can be displayed (in other words, which products T need to be replenished) on which shelf plate 411 by analyzing the captured image of the back side of the product display shelf. The product transfer apparatus 1 obtains the image of the back side of the product display shelf 410 as shown in FIG. 6.

Since the image data processing unit 155 of the product transfer apparatus 1 can obtain data of the distance to the product T (depth data Dpt visually shown in FIG. 6), it is possible to recognize the presence of a space Sp behind the product T for items such as the products T in lanes “7” and “8”, where the number of displayed products has been decreased. The product transfer apparatus 1 determines whether or not there is the space Sp for the product T based on the data of the distance to the product T, and whether or not more products T can be displayed in the lanes “7” and “8”. By the process of step S12, it is determined which products T need to be replenished on which shelf plate 411 of the product display shelf 410.

It should be noted that the method of determining whether or not products need to be replenished is not limited to the method described above, and various methods can be used. For example, it may be possible to determine what percentage of the products T are arranged in a given three-dimensional space and determine that the products T need to be replenished if the value is less than a predetermined standard value.

Next, in step S13, the image of the stock shelf 420 is captured. The product transfer apparatus 1 operates the arm unit 20, the horizontal movement mechanism 80, the elevation mechanism 90, and the first camera 50R to capture the image of the stock shelf 420 from the front side. For example, the product transfer apparatus 1 captures an image of the stock shelf 420 one level at a time, and obtains the capture image indicating the stock condition of the product T. It is not essential to perform image capturing of the stock shelf 420 after the image of the product display shelf 410 is captured, and image capturing of the stock shelf 420 may be performed before the image of the product display shelf 410 is captured.

Next, in step S14, the image data processing unit 155 of the product transfer apparatus 1 analyzes the image of the stock shelf 420 obtained in step S13 to identify the products arranged on the stock shelf 420. Further, the holding target identification unit 155b of the image data processing unit 155 identifies the holding position of the product. By the processes up to this point, information indicating which products T at which positions of which shelf plate 411 of the product display shelf 410 need to be replenished, information indicating the positions of the replenishment target products on the stock shelf 420 corresponding to the products T, and the holding positions of the replenishment target products are obtained by the product transfer apparatus 1.

Next, in step S15, the product transfer apparatus 1 performs product replenishment operation (pick-and-place operation) based on the above obtained information. Specifically, the operation control unit 152 of the control unit 151 of the product transfer apparatus 1 (see FIG. 5) operates the arm unit 20, the horizontal movement mechanism 80, and the elevation mechanism 90 to move the holder unit 10 toward a predetermined replenishment target product on the stock shelf 420. Then, the holder unit 10 holds the previously identified holding position of the replenishment target product, and, lifts the replenishment target product. Then, the operation control unit 152 operates the arm unit 20, the horizontal movement mechanism 80, and the elevation mechanism 90 to move the held product T to a predetermined placement position on the product display shelf 410, and releases the product T from the holder unit 10 to place the product T at a predetermined position. Thereafter, the product transfer apparatus 1 repeats the pick-and-place operation in the same manner to complete replenishment of the products T.

The above series of processes are the basic operations of the product transfer apparatus 1 for automatically replenishing the products T from the stock shelf 420 to the product display shelf 410. In the product replenishment operation (pick-and-place operation) in step S15 of the series of processes as described above, in the case of reaching a state where the product T held by the holder unit 10 is tilted obliquely, if operation of placing the product T onto the shelf plate 411 of the shelf plate 411 of the product display shelf 410 is performed in this state, the product may fall over, and hinder display or replenishment of the other products T. The present embodiment provides means for determining whether or not the product T held by the holder unit 10 is brought into a posture where the product T can be placed on the shelf plate 411, before operation of placing the product in the product replenishment operation (pick and place operation).

### First Operation Example

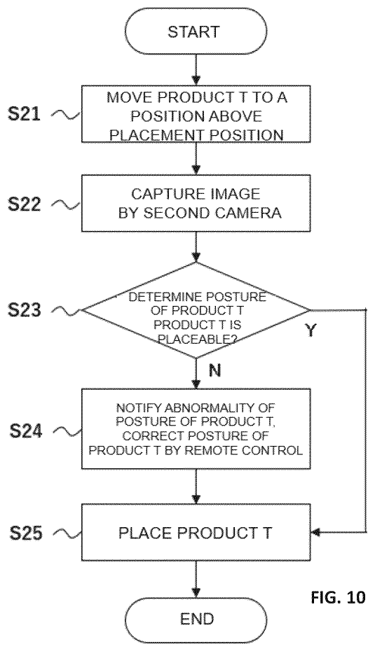

FIG. 10 is a flow chart showing a first operation example of the product transfer apparatus 1 of the present embodiment.

Firstly, in step S21, the operation control unit 152 of the control unit 151 of the product transfer apparatus 1 (see FIG. 5) operates the holder unit 10, the arm unit 20, the horizontal movement mechanism 80, and the elevation mechanism 90 to hold the product T as a target of replenishment in the stock shelf 420, and moves the product to a position above the placement position of the product display shelf 410. This step S21 corresponds to operation until the product T is released from the holder unit 10 in step S15 described above.

Next, in step S22, the image capture control unit 153 of the control unit 151 of the product transfer apparatus 1 (see FIG. 5) captures an image by the second camera 60. Thus, the capture image including the holder unit 10, and a lower portion and at least portions of both left and right sides of the product T held by the holder unit 10 is obtained by the second camera 60. In the case where the second camera 60 has a depth sensor, the distance data is obtained as well. The obtained capture image and the distance data are stored in the acquisition data memory unit 160a of the memory unit 160. As shown in FIG. 8, the capture image obtained by the second camera 60 includes a lower portion and at least portions of both left and right sides of the product T held by the holder unit 10.

Then, in step S23, the product posture determination unit 155c in the image data processing unit 155 of the product transfer apparatus 1 analyzes capture image data captured by the second camera 60 in step S22, and determines whether or not the posture of the product T relative to the holder unit 10 (in particular, the holder member 11a, 11b) is a posture in which the product T can be placed on the shelf plate 411.

As described above, the product posture determination unit 155c obtains characteristic information regarding the posture of the product T relative to the holder unit 10 (in particular, the holder members 11a, 11b of the holder unit 10) by the arbitrary image recognition technique. Based on the obtained characteristic information, the product posture determination unit 155c identifies whether or not the product T held by the holder unit 10 is tilted relative to the holder unit 10, and moreover, at what angle the product T is tilted. As the characteristic information regarding the posture of the product T held by the holder unit 10, for example, the shape and size of the curved contour of the lower side of the product T, and the length, the distance between each other, and the direction of inclination of the two straight contours of both left and right sides of the product T, can be used. As the characteristic information, these items of information may be used alone, or may be used in combination as necessary.

In the state where the product T held by the holder unit 10 is not tilted against the holder unit 10, as shown, for example, in FIG. 8(a), the curved contour of the lower side of the product T in the capture image has a shape with a relatively large curvature, and has a relatively small size. In contrast, in the state where the product T held by the holder unit 10 is tilted in a direction toward the holder unit 10, for example, as shown in FIG. 8(b), the curved contour of the lower side of the product T in the capture image has a shape with a relatively small curvature, and has a relatively large size. Further, in the state where the product T held by the holder unit 10 is tilted in a direction away from the holder unit 10, as shown in FIG. 8(c), the curved contour of the lower side of the product T in the capture image has a relatively large curvature, and has a relatively small size in comparison with the case of FIG. 8(a).

Further, in the state where the product T held by the holder unit 10 is not tilted relative to the holder unit 10, for example, as shown in FIG. 8(a), the two straight contours of both of the left and right sides of the product T in the capture image are relatively long, or tilted in a manner that the interval between the two straight contours is narrowed toward the lower side of the product T. In contrast, in the state where the product T held by the holder unit 10 is tilted in a direction toward the holder unit 10, for example, as shown in FIG. 8(b), the two straight contours on both of the left and right sides of the product T in the capture image are relatively short, and are tilted in a manner that the interval between the two straight contours is widened toward the lower side of the product T. Further, in the case where the product T held by the holder unit 10 is tilted in a direction away from the holder unit 10, for example, as shown in FIG. 8(c), the two straight contours on both of the left and right sides of the product T in the capture image are short in comparison with the case of FIG. 8(a), and tilted in a manner that the interval between the two straight contours is narrowed toward the lower side of the product T.

In the case where the shape/size of the curved contour of the lower side of the product T is used as the characteristic information, if 1) the curvature of the curved contour is not within the predetermined range of curvature, or 2) the size of the curved contour (e.g., the length in the lateral direction) is not within a predetermined size range or if both of these conditions are satisfied, the product posture determination unit 155c determines that the posture of the product T relative to the holder unit 10 is not a posture in which the product T can be placed on the shelf plate 411. Further, in the case where the product posture determination unit 155c uses the length, the distance between each other, and the direction of inclination, etc. of the two straight contours of both of the left and right sides of the product T as the characteristic information, if 1) the two straight contours of both of the left and right sides of the product T are not within a predetermined length range, or 2) the angle formed by these straight contours is not within a predetermined angle range, or if both of these conditions are satisfied, the product posture determination unit 155c determines that the posture of the product T relative to the holder unit 10 is not a posture in which the product T can be placed on the shelf plate 411. In the case where both the curved contour of the lower side, and the two straight contours of both the right and left sides of the product T are used as the characteristic information, some or all of the above conditions can be used in combination as necessary.

In step S23, in the case where it is determined that the posture of the product T relative to the holder unit 10 is not a posture in which the product T can be placed on the shelf plate 411 (N), the process proceeds to step S24, where the operation control unit 152 of the product transfer apparatus 1 sends information to an external device (not shown) via the communication unit 195, to notify the external device of the abnormal posture of the product T and the operator operates the external device to remotely control the product transfer apparatus 1 and correct the posture of the product T held by the holder unit 10 to a posture in which the product can be placed on the shelf plate 411. The information notifying the user of the abnormal posture of the product T can be in the form of a text message such as “An abnormality has occurred in the posture of the product.” or a signal which causes a warning alarm to be generated in the external device, for example.

When the external device (not shown) receives such posture abnormality information, the operator operates the external device to switch the product transfer apparatus 1 to the remote operation mode, and remotely operates the holder unit 10 and the arm unit 20, etc. of the product transfer apparatus 1 to correct the posture of the product T held by the holder unit 10 to a posture in which the product T can be placed on the shelf plate 411. While the operator watches images that are captured by the cameras 50 to 70 of the product transfer apparatus 1 and transmitted from the product transfer apparatus 1 to the external device (not shown) and displayed on a display device of the external device, the operator operates the holder unit 10 and the arm unit 20, etc. by remote control, and for example, in the state where the bottom surface of the product T held by the holder unit 10 contacts the guard portion 411a (see FIG. 7), the operator moves the holder unit 10 to return to the front side (left side in FIG. 7), and return the posture of the product T relative to the holder unit 10 to the original posture. The remote control input from the operator inputted through the operation unit of the external device (not shown) is received by the communication unit 195, and the control device 150 operates the product transfer apparatus 1 based on the input.

After the posture correction of the product T is completed by remote control from the external device, when the operator operates the external device to switch the product transfer apparatus 1 to the original autonomous operation mode, the operation control unit 152 of the product transfer apparatus 1 operates the holder unit 10 and the arm unit 20, etc. to perform the placement operation of the product T in step S15 of the process described with reference to FIG. 9 (step S25).

In step S23, in the case where it is determined that the posture of the product T relative to the holder unit 10 is a posture in which the product T can be placed on the shelf plate (Y), the process proceeds to step S25, where the operation control unit 152 of the product transfer device 1 operates the holder unit 10 and the arm unit 20, etc. to perform the placement operation of the product T in step S15 of the process described with reference to FIG. 9. In this case, the product T is placed on the shelf plate 411 by a series of autonomous operation of the product transfer apparatus 1.

As described above, according to this operation example, before performing the operation to place the product T held by the holder unit 10 at the product placement position on the shelf plate 411, it is determined whether or not the product T has a posture in which the product T can be placed on the shelf plate 411. Therefore, in the case where the product T does not have a posture in which the product T can be placed on the shelf plate 411, it is possible to prevent a situation in which placement operation on the shelf plate 411 is performed while the product T still has such a posture, and the product T falls over on the shelf plate 411. Once the product T has fallen over on the shelf plate 411, it is difficult to operate the product transfer apparatus 1 to return the product T to the correct placement position on the shelf plate 411 by remote control. In contrast, in the case where the product T does not have a posture in which the product T can be placed on the shelf plate 411, by detecting it, since it is possible to remotely operate the holder unit 10 and the arm unit 20 of the product transfer apparatus 1 to return the posture of the product T relative to the holder unit 10 while the holder unit 10 is still holding the product T, the product display operation by the product transfer apparatus 1 can continue without requiring the support of the staff of the store where the product display shelf 410 is provided.

### Second Operation Example

The first operation example has been described as an example of determining whether or not the posture of the product T relative to the holder unit 10 is a posture in which the product T can be placed on the shelf plate 411 based on an image captured by the second camera 60 when the product T held by the holder unit 10 is placed above the product placement position on the shelf plate 411. In contrast, the second operation example provides means for determining whether or not the posture of the product T relative to the holder unit 10 is a posture in which the product T can be placed on the shelf plate 411, based on the difference between the image of the product T captured by the camera 60 when the product T is picked up by the holder unit 10 and the image of the product T captured by the camera 60 when the product T held by the holder unit 10 is placed above the product placement position on the shelf plate 411.

The operation example will be described with reference to a flow chart shown in FIG. 10. In this operation example, as operation prior to step S21 of the flow chart shown in FIG. 10, when the holder unit 10 picks up the product T from the stock shelf 420, operation of capturing an image of the product T held by the holder unit 10 by the second camera 60 is performed. Then, in step S23 of the flow chart shown in FIG. 10, the product posture determination unit 155c determines whether or not the posture of the product T relative to the holder unit 10 is a posture in which the product T can be placed on the shelf plate 411, based on the difference between an image of the product T captured by the camera 60 when the product T is picked up by the holder unit 10 and an image of the product T captured by the second camera 60 when the product T held by the holder unit 10 is placed above the product placement position on the shelf plate 411 is captured by the camera 60.

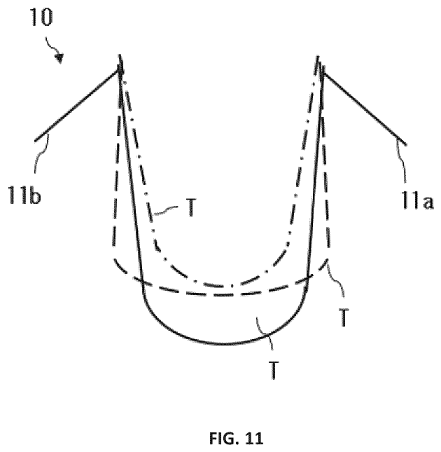

FIG. 11 is a comparative conceptual view showing a posture of the product T held by the holder unit 10, captured by the second camera 60 of the product transfer apparatus 1. A solid line shows a product T having the posture without any inclination relative the holder unit 10 when the product T is picked up by the holder unit 10. A broken line shows a product T having a posture tilted in a direction toward the holder unit 10, and a single dot line shows a product T having a posture tilted in a direction away from the holder unit 10.

In the case where the posture of the product T held by the holder unit 10 when the product T is placed above the product placement position on the shelf plate is changed from the posture of the product T picked up by the product T by the holder unit 10, a difference is generated between contours of both products T appearing in the image as shown in FIG. 11. The product posture determination unit 155c in this operation example compares the above described characteristic information in the posture of the product T relative to the holder unit 10 when the product T is picked up and the posture of the product T relative to holder unit 10 when the product T is placed above the product placement position, using an arbitrary image processing technique, and when the amount or rate of change of the characteristic information exceeds a predetermined level, the product posture determination unit 155c determines that the posture of the product T relative to the holder unit 10 is not a posture in which the product T can be placed on the shelf plate 411. As the characteristic information regarding the posture of the product T held by the holder unit 10, as described above, for example, the shape/size of the curved contour of the lower side of the product T, the length of, and the distance/inclination between the two straight contours of both of left and right sides of the product T can be used alone, or used in combination as necessary.

For example, in the case where the shape/size of the curved contour of the lower side of the product T is used as the characteristic information, if one of or both of the amount or rate of change in the curvature of the curved contour of the lower side of the product T and the amount or rate of change in the lateral dimension of the contour exceeds a predetermined level, the product posture determination unit 155c determines that the posture of the product T relative to the holder unit 10 is not the posture in which the product T can be placed on the shelf plate 411.

Other processes in this operation example are the same as those described in the first operation example with reference to the flow chart shown in FIG. 10.

### Third Operation Example

The first and second operation examples have been described as examples of determining whether the posture of the product T relative to the holder unit 10 is a posture in which the product T can be placed on the shelf plate 411, using an arbitrary image recognition technique, based on image data captured by the second camera 60, by the product posture determination unit 155c of the product transfer apparatus 1. In contrast, in the third operation example, the product posture determination unit 155c provides means for determining whether or not the product T held by the holder unit 10 has a posture in which the product T can be placed on the shelf plate 411, using a learned model generated by machine learning.

For example, the learned model used to determine whether or not the product T held by the holder unit 10 has a posture in which the product T can be placed on the shelf plate 411 may be generated in machine learning by an arbitrary learning machine comprising a computer, using teaching data and learning data. The teaching data comprises various types of image data and/or depth data including the holder unit 10 as shown in FIG. 8 and at least portion of the product T held by the holder unit 10 captured by the second camera 60 as described above, in the state where the product T is positioned above the placement position by the holder unit 10 and the arm unit 20 for allowing the holder unit 10 to place the product T at the placement position on the shelf plate 411, and annotation information regarding whether or not the product T has a placeable posture associated with each data. The learning data is the image data and/or the depth data including the holder unit 10 and at least a portion of the product T held by the holder unit 10.

Such a learned model can be generated, for example, by performing machine learning on a neural network comprising multiple layers including neurons in each layer. Deep neural networks, such as convolutional neural networks (CNN: Convolutional Neural Network) having 20 or more layers, may be used as such neural networks. The machine learning using such deep neural networks is referred to as deep learning. Alternatively, the learned model as described above can be generated using “Visual Transformer” which applies Transformer as a type of deep neural network mainly based on self-attention mechanism to the field of computer vision. The learned model generated in this way is stored in the memory unit 160 of the product transfer apparatus 1 and implemented as a functional module of the product posture determination unit 155c of the product transfer apparatus 1.

In this example, in the process of step S23 described in the first operation example, for the image data captured by the second camera 60, the product posture determination unit 155c of the product transfer apparatus 1 where the learned model described above is implemented as a functional module, determines whether or not the posture of the product T relative to the holder unit 10 is a posture in which the product T can be placed on the shelf plate 411, for the product T placed above the placement position on the shelf plate 411 before being held by the holder unit 10 and placed at the placement position. In this example, since the learned model is used to determine the posture of the product T relative to the holder unit 10, in comparison with the case where the above determination is made from image data, etc., by executing a process using image recognition techniques as in the cases of the first and second operation examples, it is possible to increase the processing speed while reducing the computational cost.

Other processes in the present operation example are the same as the processes in the first operation example described with reference to a flow chart shown in FIG. 10.

### Fourth Operation Example

Each of the above operation examples has been described as an example of operation where, after moving the product T held by the holder unit 10 of the product transfer apparatus 1 to a position above the placement position (step S21 in FIG. 10), the second camera 60 obtains a capture image including the holder unit 10 and the lower side and at least portions of both of left and right sides of the product T held by the holder unit 10 (step S22), and operation of analyzing the capture image data to determine whether or not the posture of the product T relative to the holder unit 10 is the posture in which the product T can be placed on the shelf plate 411 is performed (step S23). In contrast, the fourth operation example provides means for making it possible to obtain an image of the product T and determine the posture even in the middle of moving the product T held by the holder unit 10 of the product transfer apparatus 1 to a position above the placement position, and in the state where the product T is made to have a posture in which the product T can be placed on the shelf plate 411, the product T is moved to a position above the placement position.

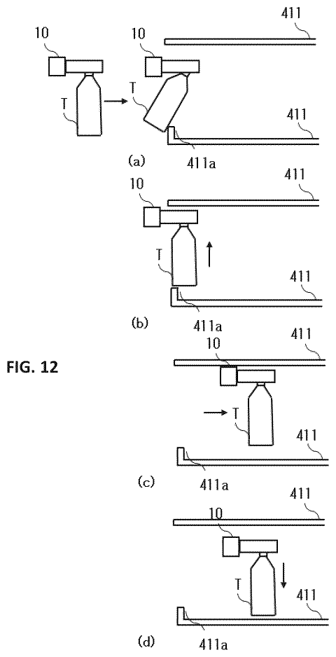

This operation example will be described with reference to the flow chart shown in FIG. 10 and FIG. 12. FIG. 12 is a schematic diagram illustrating a fourth operation example of the product transfer apparatus 1.

The control unit 151 of the product transfer apparatus 1 in this operation example (see FIG. 5) performs, even in the middle of moving the product T held by the holder unit 10 of the product transfer apparatus 1 to a position above the placement position (step S21 of FIG. 10), operation of obtaining a capture image including the holder unit 10 and the lower side and at least portions of the left and right sides of the product T held by the holder unit 10, by the second camera 60 (step S22), and operation of analyzing the capture image data to determine whether or not the posture of the product T relative to the holder unit 10 is the posture in which the product T can be placed on the shelf plate 411 (step S23).

Therefore, in this operation example, as shown in FIG. 12(a), if the product T held by the holder unit 10 is tilted obliquely relative to the holder unit 10 due to contact with the guard portion 411a while moving the product T held by the holder unit 10 to a position above the placement position of the shelf plate 411, at the time point, it is determined whether or not the posture of the product T relative to the holder unit 10 is a posture in which the product T can be placed on the shelf plate 411 (i.e., whether or not the product T is not tilted relative to the holder unit 10). Then, if it is determined that the posture of the product T is not a posture in which the product T can be placed on the shelf plate 411 (the product T is tilted relative to the holder unit 10), the control unit 151 moves the holder unit 10 which holds the product T upward until it is detected and determined that the contact of the product T with the guard portion 411a is avoided, and as a result, the product T rotates around the contact portion with the holder members 11a, 11b by its own weight and returns to the original upright posture (see 12 (b)).

Then, the control unit 151 moves the holder unit 10 to a position above the placement position of the shelf plate 411, while maintaining the height of the holder unit 10 relative to the shelf plate 411 as shown in FIG. 12(b) (see FIG. 12(c)), and after the control unit 151 moves the holder unit 10 downward by the amount that the holder unit 10 was moved upward in the operation shown in FIG. 12(b), the control unit 151 operates the holder unit 10 and the arm unit 20, etc. to perform the placement operation of the product T in step S15 of the process described with reference to FIG. 9.

Other processes in this operation example are also similar to those described in the first operation example with reference to the flow chart shown in FIG. 10.

As described above, according to this operation example, in particular, in the case where the holder unit 10 holds the outer peripheral portion of the cap member of a PET bottle beverage as the product T and moves the product T, even in the case where there is a change in the posture of the product T relative to the holder unit 10, the posture of the product T can be recovered utilizing motion of the product T rotating around the contact portion with the holder members 11a, 11b by its own weight and returning to the original upright posture. Therefore, by the series of autonomous operations without switching the product transfer apparatus 1 to the remote control mode, in the state where the product T is made to have a posture in which the product T can be placed on the shelf plate 411, it is possible to place the product T at the placement position on the shelf plate 411.

While the present disclosure has been described though embodiments of the invention, the embodiments are not intended to limit the scope of the invention as claimed. Further, any form of combination of the features described in the embodiments of the present disclosure may also be included in the technical scope of the present disclosure. Furthermore, it is also apparent to those skilled in the art that various modifications or improvements can be made to the embodiments described above.

1. A product transfer apparatus configured to move a product placed on a stock shelf to a product display shelf which is different from the stock shelf,
the product transfer apparatus comprising:
an arm unit having a holder unit configured to hold the product;
an image capture unit configured to obtain image data including the holder unit and at least a portion of the product held by the holder unit; and
a control unit configured to control operation of the holder unit, the arm unit, and the image capture unit,
wherein the control unit is configured to perform:
allowing the image capture unit to obtain image data including at least a portion of the product held by the holder unit for placing the product on the shelf plate of the product display shelf and placed at a position above the shelf plate by the arm unit; and
determining whether or not the product has a posture in which the product can be placed on the shelf plate, based on the image data.

2. The product transfer apparatus according to claim 1, wherein the determining whether or not the product has a posture in which the product can be placed on the shelf plate includes identifying a posture of the product relative to the holder unit.

3. The product transfer apparatus according to claim 2, wherein the control unit is configured to perform identifying a posture of the product relative to the holder unit, based on characteristic information obtained from a contour of the product.

4. The product transfer apparatus according to claim 2, wherein the image capture unit is configured to obtain image data including at least a portion of the product even when the product placed on the stock shelf is held by the holder unit; and
the control unit is configured to perform determining whether or not the product has a posture in which the product can be placed on the shelf plate, based on a difference between a posture of the product relative to the holder unit in the image data obtained when the product placed on the stock shelf is held by the holder unit and a posture of the product relative to the holder unit in the image data including at least a portion of the product held by the holder unit and placed at a position above the shelf plate by the arm unit.

5. The product transfer apparatus according to claim 1, wherein the control unit is configured to perform determining whether or not the product has a posture in which the product can be placed on the shelf plate using a learned model generated by machine learning beforehand using teaching data and learning data; and
the teaching data comprises various types of image data and annotation information regarding whether or not the product has a posture in which the product can be placed on the shelf plate, associated respectively with the various types of image data, and the learning data comprises various types of image data which are different from the various types of image data of the teaching data.

6. A method of controlling a product transfer apparatus for moving a product placed on a stock shelf to a product display shelf which is different from the stock shelf,
wherein the product transfer apparatus comprises:
an arm unit having a holder unit configured to hold the product;
an image capture unit configured to obtain image data including at least a portion of the product held by the holder unit; and
a control unit configured to control operation of the holder unit, the arm unit, and the image capture unit,
the method including the steps, performed by the control unit, of:
allowing the image capture unit to obtain image data including at least a portion of the product held by the holder unit for placing the product on the shelf plate of the product display shelf and placed at a position above the shelf plate by the arm unit; and
determining whether or not the product has a posture in which the product can be placed on the shelf plate, based on the image data.

7. A computer program configured to be executable by a processor, wherein the computer program includes an instruction for performing the method according to claim 6.
